(19) United States
(12) Patent Application Publication
(10) Pub. No.: US 2010/0045163 A1
(43) Pub. Date: Feb. 25, 2010

(54) PHOSPHOR BODY CONTAINING RUBY FOR WHITE OR COLOUR-ON-DEMAND LEDS

(76) Inventors: Holger Winkler, Darmstadt (DE); Klaus Ambrosius, Dieburg (DE); Thomas Juestel, Witten (DE); Katsuhisa Nitta, Fukushima-ken (JP); Kaiman Shimizu, Fukushima-ken (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/515,160

(22) PCT Filed: Oct. 25, 2007
(86) PCT No.: PCT/EP2007/009277

§ 371 Date: May 15, 2009

(30) Foreign Application Priority Data
Nov. 17, 2006 (DE) 102006054328.9
Jan. 12, 2007 (DE) 102007001903.5

(51) Int. Cl. H01J 1/62; B32B 5/16; C09K 11/08

(52) U.S. Cl. 313/486; 313/483; 313/503; 252/301.4 R; 428/402

(57) ABSTRACT

The invention relates to a phosphor element comprising Cr(III)-activated aluminium oxide (ruby), to the production thereof, and to the use thereof as LED conversion phosphor for white LEDs or so-called colour-on-demand applications.

The invention relates to a phosphor element based on a synthetic, flake-form ruby substrate, to the production thereof, and to the use thereof as LED conversion phosphor for white LEDs or so-called colour-on-demand applications.

The colour-on-demand concept is taken to mean the generation of light of a certain colour point by means of a pcLED using one or more phosphors. This concept is used, for example, to produce certain corporate designs, for example for illuminated company logos, trademarks, etc.

White phosphor-converted LEDs (pcLEDs) are dichromatic light sources consisting of a blue or near-UV electroluminescent AlInGaN chip and a yellow or yellowish green or yellowish orange phosphor, usually YAG:Ce or derivatives thereof or orthosilicates Me₂SiO₄:Eu (where Me=Ca, Sr, Ba). However, these pcLEDs are of only limited suitability for a large number of light applications since their emitted light has high light temperatures and only low colour rendering. The reason for this is the lack of red component in the pcLED light. There are a number of approaches to adding reddish light to the spectrum of pcLEDs. For example, pcLEDs comprising the following red phosphors are already commercially available: “Lumileds Luxeon I warm white” with yellow YAG:Ce and reddish CaS:Eu²⁺ and “Nichia Jupiter warm white” with YAG:Ce and reddish nitridosilicate:Eu²⁺. The sulfidic phosphors CaS:Eu and SrS:Eu are chemically unstable, i.e. they hydrolyse under operating conditions and in the operating environment in the LED, causing their colour point to shift to higher colour temperatures in the course of time during operation of the LED fitted therewith, ultimately with bluish white light again being produced. Nitridosilicates and oxynitrido-silicates are very difficult to prepare industrially. Although they have higher chemical stability than sulfidic phosphors, they still decompose hydrolytically. In addition, the hydrolysis products both of the sulfidic and of the nitridic phosphors result in corrosion of components of the LED, which further impairs the properties thereof, in addition to the colour-point shift. The reddish phosphors mentioned above are band emitters, meaning that a large proportion of the photons emitted by them are not perceived as red by the eye: the reddish bands have outliers in the IR region and in the orange region. A red phosphor with an optimum action must have a line spectrum whose peak is in the deep-red region of the spectrum (600-750 nm). In this way, high lumen equivalents can be achieved with red line emitters, in contrast to the red band emitters.

The phosphors currently used for white pcLEDs which contain a blue-emitting chip as primary emitter are principally YAG:Ce³⁺ or derivatives thereof or orthosilicate:Eu²⁺.

The phosphors are prepared by solid-state diffusion processes (“mixing and firing”) by mixing oxidic starting materials as powders, grinding the mixture and then calcining the mixture in an oven at temperatures up to 1700° C. for up to several days in an optionally reducing atmosphere. This gives phosphor powders which have inhomogeneities in relation to the morphology, the particle-size distribution and the distribution of the luminescent activator ions in the volume of the matrix. Furthermore, the morphology, particle-size distributions and further properties of these phosphors prepared by the traditional process can only be adjusted poorly and are difficult to reproduce. These particles therefore have a number of disadvantages, such as, in particular, inhomogeneous coating of the LED chips with these phosphors having non-optimal and inhomogeneous morphology and particle-size distribution, which result in high loss processes due to scattering. Further losses arise in the production of these LEDs through the fact that the phosphor coating of the LED chips is not only inhomogeneous, but is also not reproducible from LED to LED. This results in variations of the colour points of the emitted light from the pcLEDS even within a batch. This makes a complex sorting process of the LEDs (so-called binning) necessary. The phosphor particles are applied to the LED by a complex process. To this end, the phosphor particles are dispersed in a binder, usually silicones or epoxides, and one or more drops of this dispersion are applied to the chip. While the binder hardens, non-uniform sedimentation behaviour occurs in the phosphor particles due to different morphology and size, resulting in inhomogeneous coating within an LED and from LED to LED. For this reason, complex classification processes have to be carried out (so-called binning), where the LEDs are sorted according to whether they meet or do not meet optical target parameters, such as the distribution of optical parameters within the light cone with respect to distribution of the colour temperature, chromaticity (x,y values within the CIE chromaticity diagram), and the optical performance, in particular the light flux expressed in lumens and the lumen efficiency (lm/W). This sorting results in a reduction in the time yield of LED units per machine day since >>30% of the LEDs are usually rejected. This situation results in the high unit costs, in particular of power LEDs (i.e. LEDs having a power requirement of greater than 0.5 W), which can be at prices of several US $ per unit, even in the region of purchase quantities of more than 10,000 units.

The object of the present invention is therefore to provide a phosphor, preferably a conversion phosphor for white LEDs or for colour-on-demand applications, which does not have one or more of the above-mentioned disadvantages and produces warm-white light.

Surprisingly, the present object can be achieved in that ruby can be prepared synthetically as phosphor in flake form by wet-chemical methods. These rubies can therefore be produced very inexpensively and are suitable as conversion phosphor for pcLEDs for the production of warm-white light with high efficiency and superior colour rendering owing to deep-red emission. Cr³⁺, which is present as dopant in the crystalline Al₂O₃ matrix and produces a line emission spectrum, is responsible for the deep-red colour.

These phosphor flakes can be produced in a wet-chemical process which gives Al₂O₃ flakes doped with 0.01 to 10% by weight of Cr³⁺ or Cr₂O₃ which have a very large aspect ratio, an atomically smooth surface and an adjustable thickness.

In a further preferred embodiment, these phosphor flakes can be produced by coating a synthetically prepared support or a substrate comprising a synthetically prepared Al₂O₃ flake which has been doped with 0.01 to 10% by weight of Cr³⁺ or Cr₂O₃ and has a very large aspect ratio, an atomically smooth surface and an adjustable thickness with a phosphor layer by precipitation reaction in aqueous suspension.

The process according to the invention for the preparation of these phosphors and the use of these phosphors in LEDs gives rise for the first time to the situation that warm-white LEDs with a stable colour point are possible or stable colour points can be achieved for colour-on-demand LED applications with red light components. Furthermore, a reduction in the production costs of white LEDs and/or LEDs for colour-on-demand applications arises since the phosphor-induced inhomogeneity and low batch-to-batch reproducibility of the light properties of LEDs are eliminated and the application of the phosphor to the LED chip is simplified and accelerated. Furthermore, the light yield of white LEDs and/or colour-on-demand applications can be increased with the aid of the process according to the invention. Overall, the costs of the LED light become lower because:
the costs per LED become lower (investment costs for the customers)
more light is obtained from an LED (more favourable lumen/EUR ratio)
overall, the total cost of ownership, which describes the light costs as a function of the investment costs, the maintenance costs and the operating and replacement costs, becomes more favourable.

The present invention thus relates to a phosphor element comprising Cr(III)-activated aluminium oxide (ruby).

In accordance with the invention, the term “phosphor element” is taken to mean a flake-form element of defined dimensions which consists of the phosphor according to the invention and optionally further conversion phosphors.

The phosphor element according to the invention can easily be excited by the yellow emission from YAG:Ce or, for example, from orthosilicate phosphors. It is therefore preferred for the ruby-containing phosphor element according to the invention to comprise at least one further conversion phosphor (for example YAG:Ce) or for the phosphor according to the invention to be employed in a mixture with further conversion phosphors. Some of the yellow light emitted by YAG:Ce or the orthosilicates is absorbed by the ruby-containing phosphor element, while the vast majority of the yellow light is transmitted if small amounts of the ruby phosphor are used (5-30% by weight based on the weight of the yellow phosphor). In accordance with the invention, the term “YAG:Ce” here is taken to mean all compositions of the general formula (Y,Gd,Tb,Lu,Pr)₃(Al,Ga)₅O₁₂.

The deep-red phosphor element according to the invention has a high quantum yield of 86%. The light emitted by the LED is then composed additively of the blue (or UV) light, the yellow light (from a further conversion phosphor) and the deep-red light from the ruby-containing phosphor element (see FIG. 2, emission spectrum of the phosphor element according to the invention). However, the blue or UV light may also be absorbed completely by the phosphor(s). Variation of the respective proportions enables the setting of all colour points in the chromaticity diagram which are within the triangle defined by the colour coordinates of the individual constituents.

It is preferred for the doping concentration of the chromium to be between 0.01 and 10% by weight. It is particularly preferably between 0.03 and 2.5% by weight.

In particular, the further material selected for the phosphor elements according to the invention besides Cr(III)-activated aluminium oxide can be the following compounds or phosphors, where, in the following notation, the host lattice is shown to the left of the colon and one or more doping elements are shown to the right of the colon. If chemical elements are separated from one another by commas and bracketed, they can be used optionally. Depending on the desired luminescence property of the phosphor elements, one or more of the compounds provided for selection can be used:

BaAl₂O₄:Eu²⁺, BaAl₂S₄:Eu²⁺, BaB₈O₁₋₃:Eu²⁺, BaF₂, BaFBr:Eu²⁺, BaFCl:Eu²⁺, BaFCl:Eu²⁺, Pb²⁺, BaGa₂S₄:Ce³⁺, BaGa₂S₄:Eu²⁺, Ba₂Li₂Si₂O₇:Eu²⁺, Ba₂Li₂Si₂O₇:Sn²⁺, Ba₂Li₂Si₂O₇:Sn²⁺, Mn²⁺, BaMgAl₁₀O₁₇:Ce³⁺, BaMgAl₁₀O₁₇:Eu²⁺, BaMgAl₁₀O₁₇:Eu²⁺, Mn²⁺, Ba₂Mg₃F₁₀:Eu²⁺, BaMg₃F₈:Eu²⁺, Mn²⁺, Ba₂MgSi₂O₇:Eu²⁺, BaMg₂Si₂O₇:Eu²⁺, Ba₅(PO₄)₃Cl:Eu²⁺, Ba₅(PO₄)₃Cl:U, Ba₃(PO₄)₂:Eu²⁺, BaS:Au,K, BaSO₄:Ce³⁺, BaSO₄:Eu²⁺, Ba₂SiO₄:Ce³⁺, Li⁺, Mn²⁺, Ba₅SiO₄Cl₆:Eu²⁺, BaSi₂O₅:Eu²⁺, Ba₂SiO₄:Eu²⁺, BaSi₂O₅:Pb²⁺, BaₓSri₁₋ₓF₂:Eu²⁺, BaSrMgSi₂O₇:Eu²⁺, BaTiP₂O₇, (Ba,Ti)₂P₂O₇:Ti, Ba₃WO₆:U, BaY₂F₈Er³⁺, Yb⁺, Be₂SiO₄:Mn²⁺, Bi₄Ge₃O₁₂, CaAl₂O₄:Ce³⁺, CaLa₄O₇:Ce³⁺, CaAl₂O₄:Eu²⁺, CaAl₂O₄:Mn²⁺, CaAl₄O₇:Pb²⁺, Mn²⁺, CaAl₂O₄:Tb³⁺, Ca₃Al₂Si₃O₁₂:Ce³⁺, Ca₃Al₂Si₃Oi₂:Ce³⁺, Ca₃Al₂Si₃O₁₂:Eu²⁺, Ca₂B₅O₉Br:Eu²⁺, Ca₂B₅O₉Cl:Eu²⁺, Ca₂B₅O₉Cl:Pb²⁺, CaB₂O₄:Mn²⁺, Ca₂B₂O₅:Mn²⁺, CaB₂O₄:Pb²⁺, CaB₂P₂O₉:Eu²⁺, Ca₅B₂SiO₁₀:Eu³⁺, Ca_{0.5}Ba_{0.5}Al₁₂O₁₉:Ce³⁺, Mn²⁺, Ca₂Ba₃(PO₄)₃Cl:Eu²⁺, CaBr₂:Eu²⁺ in SiO₂, CaCl₂:Eu²⁺ in SiO₂, CaCl₂:Eu²⁺, Mn²⁺ in SiO₂, CaF₂: Ce³⁺, CaF₂:Ce³⁺, Mn²⁺, CaF₂:Ce³⁺, Tb³⁺, CaF₂:Eu²⁺, CaF₂:Mn²⁺, CaF₂:U, CaGa₂O₄:Mn²⁺, CaGa₄O₇:Mn²⁺, CaGa₂S₄:Ce³⁺, CaGa₂S₄:Eu²⁺, CaGa₂S₄:Mn²⁺, CaGa₂S₄:Pb²⁺, CaGeO₃:Mn²⁺, Cal₂:Eu²⁺ in SiO₂, Cal₂:Eu²⁺, Mn²⁺ in SiO₂, CaLaBO₄:Eu³⁺, CaLaB₃O₇:Ce³⁺, Mn²⁺, Ca₂La₂BO_{6.5}:Pb²⁺, Ca₂MgSi₂O₇, Ca₂MgSi₂O₇:Ce³⁺, CaMgSi₂O₆:Eu²⁺, Ca₃MgSi₂O₈:Eu²⁺, Ca₂MgSi₂O₇:Eu²⁺, CaMgSi₂O₆:Eu²⁺, Mn²⁺, Ca₂MgSi₂O₇:Eu²⁺, Mn²⁺, CaMoO₄, CaMoO₄:Eu³⁺, CaO:Bi³⁺, CaO:Cd²⁺, CaO:Cu⁺, CaO:Eu³⁺, CaO:Eu³⁺, Na⁺, CaO:Mn²⁺, CaO:Pb²⁺, CaO:Sb³⁺, CaO:Sm³⁺, CaO:Tb³⁺, CaO:Tl, CaO.Zn²⁺, Ca₂P₂O₇:Ce³⁺, α-Ca₃(PO₄)₂:Ce³⁺, β-Ca₃(PO₄)₂:Ce³⁺, Ca₅(PO₄)₃Cl:Eu²⁺, Ca₅(PO₄)₃Cl:Mn²⁺, Ca₅(PO₄)₃Cl:Sb³⁺, Ca₅(PO₄)₃Ci:Sn²⁺, β-Ca₃(PO₄)₂:Eu²⁺, Mn²⁺, Ca₅(PO₄)₃F:Mn²⁺, Ca₅(PO₄)₃F:Sb³⁺, Ca₈(PO₄)₃F:Sn²⁺, α-Ca₃(PO₄)₂:Eu²⁺, β-Ca₃(PO₄)₂:Eu²⁺, Ca₂P₂O₇:Eu²⁺, Ca₂P₂O₇:Eu²⁺, Mn²⁺, CaP₂O₆:Mn²⁺, α-Ca₃(PO₄)₂:Pb²⁺, α-Ca₃(PO₄)₂:Sn²⁺, β-Ca₃(PO₄)₂:Sn²⁺, β-Ca₂P₂O₇:Sn,Mn, α-Ca₃(PO₄)₂:Tr, CaS:Bi³⁺, CaS:Bi³⁺, Na, CaS:Ce³⁺, CaS:Eu²⁺, CaS:Cu⁺, Na⁺, CaS:La³⁺, CaS:Mn²⁺, CaSO₄:Bi, CaSO₄:Ce³⁺, CaSO₄:Ce³⁺, Mn²⁺, CaSO₄:Eu²⁺, CaSO₄:Eu²⁺, Mn²⁺, CaSO₄:Pb²⁺, CaS:Pb²⁺, CaS:Pb²⁺, Cl, CaS:Pb²⁺, Mn²⁺, CaS:Pr³⁺, Pb²⁺, Cl, CaS:Sb³⁺, CaS:Sb³⁺, Na, CaS:Sm³⁺, CaS:Sn²⁺, CaS:Sn²⁺, F, CaS:Tb³⁺, CaS:Tb³⁺, Cl, CaS:Y³⁺, CaS:Yb³⁺, CaS:Yb²⁺, Cl, CaSiO₃:Ce³⁺, Ca₃SiO₄Cl₂:Eu²⁺, Ca₃SiO₄Cl₂:Pb²⁺, CaSiO₃:Eu²⁺, CaSiO₃:Mn²⁺, Pb, CaSiO₃:Pb²⁺, CaSiO₃:Pb²⁺, Mn²⁺, CaSiO₃:Ti⁴⁺, CaSr₂(PO₄)₂:Bi³⁺, β-(Ca, Sr)₃(PO₄)₂:Sn²⁺Mn²⁺, CaTi_{0.9}Al₀₋₁O₃:Bi³⁺, CaTiO₃:Eu³⁺, CaTiO₃:Pr³⁺, Ca₅(VO₄)₃Cl, CaWO₄, CaWO₄:Pb²⁺, CaWO₄:W, Ca₃WO₆:U, CaYAlO₄:Eu³⁺, CaYBO₄:Bi³⁺, CaYBO₄:Eu³⁺, CaYB₀₋₈O₃₋₇:Eu³⁺, CaY₂ZrO₆:Eu³⁺, (Ca,Zn,Mg)₃(PO₄)₂:Sn, CeF₃, (Ce₁Mg)BaAl₁₁O₁₈:Ce, (Ce,Mg)SrAl₁₁O₁₈:Ce, CeMgAl₁₁O₁₉:Ce:Tb, Cd₂B₆O₁₁:Mn²⁺, CdS:Ag⁺,Cr, CdS:In, CdS:In, CdS:In, Te, CdS:Te, CdWO₄, CsF, CsI, CsI:Na⁺, CsI:Tl, (ErCl₃)_{0.25}(BaCl₂)_{0.75}, GaN:Zn, Gd₃Ga₅O₁₂:Cr³⁺, Gd₃Ga₅O₁₂:Cr, Ce, GdNbO₄:Bi³⁺, Gd₂O₂S:Eu³⁺, Gd₂O₂Pr³*, Gd₂O₂S:Pr, Ce,F, Gd₂O₂S:Tb³⁺, Gd₂SiO₆:Ce³⁺, KAl₁₁O₁₇:Tl⁺, KGa₁₁O₁₇:Mn²⁺, K₂La₂Ti₃O₁₀:Eu, KMgF₃:Eu²⁺, KMgF₃:Mn²⁺, K₂SiF₆:Mn⁴⁺, LaAl₃B₄O₁₂:Eu³⁺, LaAlB₂O₆:Eu³⁺, LaAlO₃:Eu³⁺, LaAlO₃:Sm³⁺, LaAsO₄:Eu³⁺, LaBr₃:Ce³⁺, LaBO₃:Eu³⁺, (La, Ce, Tb)PO₄:Ce:Tb, LaCl₃:Ce³⁺, La₂O₃:Bi³⁺, LaOBr:Tb³⁺, LaOBr:Tm³⁺, LaOCl:Bi³⁺, LaOCl:Eu³⁺, LaOF:Eu³⁺, La₂O₃:Eu³⁺, La₂O₃:Pr³⁺, La₂O₂S:Tb³⁺, LaPO₄:Ce³⁺, LaPO₄:Eu³⁺, LaSiO₃Cl:Ce³⁺, LaSiO₃Cl:Ce³⁺, Tb³⁺, LaVO₄:Eu³⁺, La₂W₃O₁₂:Eu³⁺, LiAlF₄:Mn²⁺, LiAl₅O₈:Fe³⁺, LiAlO₂:Fe³⁺, LiAlO₂:Mn²⁺, LiAl₅O₈:Mn²⁺, Li₂CaP₂O₇:Ce³⁺, Mn²⁺, LiCeBa₄Si₄O₁₄: Mn²⁺, LiCeSrBa₃Si₄O₁₄:Mn²⁺, LiInO₂:Eu³⁺, LiInO₂:Sm³⁺, LiLaO₂:Eu³⁺, LuAlO₃:Ce³⁺, (Lu,Gd)₂SiO₅:Ce³⁺, Lu₂SiO₅:Ce³⁺, Lu₂Si₂O₇:Ce³⁺, LuTaO₄:Nb⁵⁺, Lu₁₋ₓYₓAlO₃:Ce³⁺, MgAl₂O₄:Mn²⁺, MgSrAl₁₀O₁₇:Ce, MgB₂O₄:Mn²⁺, MgBa₂(PO₄)₂:Sn²⁺, MgBa₂(PO₄)₂:U, MgBaP₂O₇:Eu²⁺, MgBaP₂O₇: Eu²⁺, Mn²⁺, MgBa₃Si₂O₈ Eu²⁺, MgBa(SO₄)₂:Eu²⁺, Mg₃Ca₃(PO₄)₄:Eu²⁺, MgCaP₂O₇:Mn²⁺, Mg₂Ca(SO₄)₃:Eu²⁺, Mg₂Ca(SO₄)₃: Eu²⁺, Mn², MgCeAlₙO₁₉:Tb³⁺, Mg₄(F)GeO₆:Mn²⁺, Mg₄(F)(Ge,Sn)O₆:Mn²⁺, MgF₂:Mn²⁺, MgGa₂O₄:Mn²⁺, Mg₈Ge₂O₁₁F₂:Mn⁴⁺, MgS:Eu²⁺, MgSiO₃:Mn²⁺, Mg₂SiO₄:Mn²⁺, Mg₃SiO₃F₄:Ti⁴⁺, MgSO₄:Eu²⁺, MgSO₄:Pb²⁺, MgSrBa₂Si₂O₇:Eu⁺, MgSrP₂O₇:Eu²⁺, MgSr₅(PO₄)₄:Sn²⁺, MgSr₃Si₂O₈:Eu²⁺, Mn²⁺, Mg₂Sr(SO₄)₃:Eu²⁺, Mg₂TiO₄:Mn⁴⁺, MgWO₄, MgYBO₄:Eu³⁺, Na₃Ce(PO₄)₂:Tb³⁺, NaI:Tl, Na₁₋₂₃K₀₋₄₂Eu₀₋₁₂TiSi₄O₁₁:Eu³⁺, Na_{1.23}K_{0.42}Eu_{0.12}TiSi₅O₁₃.xH₂O:Eu³⁺, Na_{1.29}K_{0.46}Er_{0.08}TiSi₄O₁₁:Eu³⁺, Na₂Mg₃Al₂Si₂O₁₀:Tb, Na(Mg₂₋ₓMnₓ)LiSi₄O₁₀F₂:Mn, NaYF₄:Er⁺, Yb³⁺, NaYO₂:Eu³⁺, P46(70%)+P47 (30%), SrAl₁₂O₁₉:Ce³⁺, Mn²⁺, SrAl₂O₄:Eu²⁺, SrAl₄O₇Eu³⁺, SrAl₁₂O₁₉:Eu²⁺, SrAl₂S₄:Eu²⁺, Sr₂B₅O₉Ci:Eu²⁺, SrB₄O₇:Eu²⁺(F,C1,Br), SrB₄O₇:Pb²⁺, SrB₄O₇:Pb²⁺, Mn²⁺, SrB₈O₁₃:Sm²⁺, SrₓBa_{y}Cl_{z}Al₂O_{4-z/2}:Mn²⁺, Ce³⁺, SrBaSiO₄:Eu²⁺, Sr(Cl,Br,I)₂:Eu²⁺ in SiO₂, SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Ei²⁺, Sm²⁺, SrF₂:Eu²⁺, SrGa₁₂O₁₉:Mn²⁺, SrGa₂S₄:Ce³⁺, SrGa₂S₄:Eu²⁺, SrGa₂S₄:Pb²⁺, SrIn₂O₄:Pr³⁺, Al³⁺, (Sr,Mg)₃(PO₄)₂;SnF SrMgSi₂O₆:Eu²⁺, Sr₂MgSi₂O₇:Eu²⁺, Sr₃MgSi₂O₈:Eu²⁺, SrMoO₄:U, SrO.3B₂O₃:Eu²⁺, Cl, β-SrO.3B₂O₃:Pb²⁺, β-SrO.3B₂O₃:Pb²⁺, Mn²⁺, α-SrO.3B₂O₃:Sm²⁺, Sr₆P₅BO₂₀:Eu, Sr₅(PO₄)₃Cl:Eu²⁺, Sr₅(PO₄)₃Cl:Eu²⁺, Pr³⁺, Sr₅(PO₄)₃F:Mn²⁺, Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺, Sr₅(PO₄)₃F:Sb³⁺, Sr₅(PO₄)₃F:Sb³⁺, Mn , Sr₅(PO₄)₃F:Sn²⁺, Sr₂P₂O₇:Sn²⁺, β-Sr₃(PO₄)₂:Sn²⁺, β-Sr₃(PO₄)₂:Sn²⁺, Mn²⁺(Al), SrS:Ce³⁺, SrS:Eu²⁺, SrS:Mn²⁺, SrS:Cu⁺, Na, SrSO₄:Bi, SrSO₄:Ce³⁺, SrSO₄:Eu²⁺, SrSO₄:Eu²⁺, Mn²⁺, Sr₅Si₄O₁₀Cl₆:Eu²⁺, Sr₂SiO₄:Eu²⁺, SrTiO₃:Pr³⁺, SrTiO₃:Pr³⁺, Al³⁺, Sr₃WO₆:U, SrY₂O₃:Eu³⁺, ThO₂:Eu³⁺, ThO₂:Pr³⁺, ThO₂:Tb³⁺, YAl₃B₄O₁₂:Bi³⁺, YAl₃B₄O₁₂:Ce³⁺, YAl₃B₄O₁₂:Ce³⁺, Mn, YAl₃B₄O₁₂:Ce³⁺, Tb³⁺, YAl₃B₄O₁₂:Eu³⁺, YAl₃B₄O₁₂:Eu³⁺, Cr³⁺, YAl₃B₄O₁₂:Th⁴⁺, Ce³⁺, Mn²⁺, YAlO₃:Ce³⁺, Y₃Al₅O₁₂:Ce³⁺, (Y,Gd,Lu,Tb)₃(Al, Ga)₅O₁₂:(Ce,Pr,Sm), Y₃Al₅O₁₂:Cr³⁺, YAlO₃:Eu³⁺, Y₃Al₅O₁₂:Eu^{3r}, Y₄Al₂O₉:Eu³⁺, Y₃Al₅O₁₂:Mn⁴⁺, YAlO₃:SM³⁺, YAlO₃;Tb³⁺, Y₃Al₅O₁₂:Tb³⁺, YAsO₄:Eu³⁺, YBO₃:Ce³⁺, YBO₃:Eu³⁺, YF₃:Er³+₁Yb³⁺, YF₃:Mn²⁺, YF₃:Mn²⁺, Th⁴⁺, YF₃:Tm³⁺, Yb³⁺(Y,Gd)BO₃:Eu, (Y,Gd)BO₃:Tb, (Y,Gd)₂O₃:Eu³⁺, Y_{1.34}Gd_{0.60}O₃(Eu,Pr), Y₂O₃:Bi³⁺, YOBrnEu³⁺, Y₂O₃:Ce, Y₂O₃:Er³⁺, Y₂O₃:Eu³⁺(YOE), Y₂O₃:Ce³⁺,Tb³⁺, YOCl:Ce³⁺, YOCl:Eu³⁺, YOF:Eu³⁺, YOF:Tb³⁺, Y₂O₃:Ho³⁺, Y₂O₂S:Eu³⁺, Y₂O₂S:Pr³⁺, Y₂O₂S:Tb³⁺, Y₂O₃:Tb³⁺, YPO₄:Ce³⁺, YPO₄:Ce³⁺, Tb³⁺, YPO₄:Eu³⁺, YPO₄:Mn²⁺, Th⁴⁺, YPO₄;V⁵⁺, Y(P,V)O₄:Eu, Y₂SiO₅:Ce³⁺, YTaO₄, YTaO₄:Nb⁵⁺, YVO₄:Dy³⁺, YVO₄:Eu³⁺, ZnAl₂O₄:Mn²⁺, ZnB₂O₄:Mn²⁺, ZnBa₂S₃:Mn²⁺, (Zn,Be)₂SiO₄:Mn²⁺, ZnO_{0.4}Cd_{0.6}S:Ag, Zn_{0.6}Cd_{0.4}S:Ag, (Zn,Cd)S:Ag, Cl, (Zn, Cd)S:Cu, ZnF₂:Mn²⁺, ZnGa₂O₄, ZnGa₂O₄:Mn²⁺, ZnGa₂S₄:Mn²⁺, Zn₂GeO₄:Mn²⁺, (Zn,Mg)F₂:Mn²⁺, ZnMg₂(PO₄)₂:Mn²⁺, (Zn,Mg)₃(PO₄)₂: Mn²⁺, ZnO:Al³⁺, Ga³⁺, ZnO:Bi³⁺, ZnO:Ga³⁺, ZnO:Ga, ZnO—CdO:Ga, ZnO:S, ZnO:Se, ZnO:Zn, ZnS:Ag⁺, Cl⁻, ZnS:Ag, Cu, Cl, ZnS:Ag,Ni, ZnS:Au, In, ZnS-CdS (25-75), ZnS-CdS (50-50), ZnS-CdS (75-25), ZnS-CdS:Ag, Br, Ni, ZnS-CdS:Ag⁺, Cl, ZnS-CdS:Cu, Br, ZnS-CdS:Cu, I, ZnS:Cl⁻, ZnS:Eu²⁺, ZnS:Cu, ZnS:Cu⁺,Al³⁺, ZnS:Cu⁺, CI⁻, ZnS;Cu, Sn, ZnS:Eu²⁺, ZnS:Mn²⁺, ZnS:Mn, Cu, ZnS:Mn²⁺, Te²⁺, ZnS:P, ZnS:P³⁻, Cl, ZnS:Pb²⁺, ZnS:Pb²⁺, Cl⁻, ZnS:Pb, Cu, Zn₃(PO₄)₂:Mn²⁺, Zn₂SiO₄:Mn²⁺, Zn₂SiO₄:Mn²⁺, As⁵⁺, Zn₂SiO₄:Mn, Sb₂O₂, Zn₂SiO₄:Mn²⁺, P, Zn₂SiO₄:Ti⁴⁺, ZnS:Sn²⁺, ZnS:Sn, Ag, ZnS:Sn²⁺, Li⁺, ZnS:Te,Mn, ZnS-ZnTe:Mn²⁺, ZnSe:Cu⁺, Cl, ZnWO₄.

Besides Cr(III)-activated aluminium oxide, the phosphor element preferably consists of at least one further phosphor material from the following: (Y,Gd,Lu,Sc,Sm,Tb)₃(Al,Ga)₅O₁₂:Ce (with or without Pr), (Ca,Sr,Ba)₂SiO₄:Eu, YSiO₂N:Ce, Y₂Si₃O₃N₄:Ce, Gd₂Si₃O₃N₄:Ce, (Y,Gd,Tb,Lu,Sm,Sc)₃Al₅₋ₓSiₓO₁₂₋ₓNₓ:Ce, SrAl₂O₄:Eu, Sr₄Al₁₄O₂₅:Eu, (Ba,Sr, Ca)Si₂N₂O₂: Eu, SrSiAl₂O₃N₂:Eu, (Ca,Sr,Ba)₂Si₅NB:Eu, (Ca,Sr)AlSiN₃:Eu, zinc/alkaline earth metal orthosilicates, copper/alkaline earth metal orthosilicates, iron/alkaline earth metal orthosilicates, molybdates, tungstates, vanadates, group III nitrides, oxides, in each case individually or mixtures thereof with one or more activator ions, such as Ce, Eu, Mn, Cr and/or Bi.

The phosphor element can be produced on a large industrial scale as flakes in thicknesses of 50 nm to about 20 μm, preferably between 150 nm and 5 μm. The diameter here is from 50 nm to 20 μm. It generally has an aspect ratio (ratio of the diameter to the particle thickness) of 1:1 to 400:1, and in particular 3:1 to 100:1.

The flake dimension (length×width) is dependent on the arrangement.

The flakes according to the invention are also suitable as centres of scattering within the conversion layer, in particular if they have particularly small dimensions.

The surface of the phosphor element according to the invention facing the LED chip can be provided with a coating which has a reflection-reducing action in relation to the primary radiation emitted by the LED chip. This results in a reduction in back-scattering of the primary radiation, enhancing coupling of the latter into the phosphor element according to the invention.

Suitable for this purpose are, for example, refractive index-adapted coatings, which must have a following thickness d: d=[wavelength of the primary radiation from the LED chip/(4*refractive index of the phosphor ceramic)], see, for example, Gerthsen, Physik [Physics], Springer Verlag, 18th Edition, 1995. This coating may also consist of photonic crystals, which also includes structuring of the surface of the flake-form phosphor element in order to achieve certain functionalities.

In a further preferred embodiment, the flake-form phosphor element has a structured (for example pyramidal) surface on the side opposite an LED chip (see FIG. 3). This enables the largest possible amount of light to be coupled out of the phosphor element. Otherwise, light which hits the flake-form phosphor element/environment interface at a certain angle, the critical angle, experiences total reflection, resulting in undesired conduction of the light within the phosphor element.

The structured surface on the phosphor element is produced by subsequent coating with a suitable material which has already been structured, or in a subsequent step by (photo)lithographic processes, etching processes or by writing processes using energy or material beams or the action of mechanical forces.

A further possibility consists in structuring the surface of the phosphor according to the invention itself by the use of the above-mentioned processes.

In a further preferred embodiment, the phosphor element according to the invention has, on the side opposite an LED chip, a rough surface (see FIG. 3) which carries nanoparticles of SiO₂, TiO₂, Al₂O₃, ZnO₂, ZrO₂ and/or Y₂O₃ or combinations of these materials or of particles comprising the phosphor composition. A rough surface here has a roughness of up to a few 100 nm. The coated surface has the advantage that total reflection can be reduced or prevented and the light can be coupled out of the phosphor element according to the invention better.

In a further preferred embodiment, the phosphor element according to the invention has a refractive index-adapted layer on the surface facing away from the chip, which simplifies the coupling-out of the primary radiation and/or the radiation emitted by the phosphor element.

In a further preferred embodiment, the phosphor element has a polished surface in accordance with DIN EN ISO 4287 (roughness profile test; polished surfaces have roughness class N3-N1) on the side facing an LED chip. This has the advantage that the surface area is reduced, causing less light to be scattered back.

In addition, this polished surface may also be provided with a coating which is transparent to the primary radiation, but reflects the secondary radiation.

The secondary radiation can then only be emitted upwards. It is also preferred for the side of the phosphor element facing an LED chip to have a surface provided with antireflection properties for the radiation emitted by the LED.

The starting materials for the production of the phosphor element consist of the base material (for example salt solutions of aluminium) and at least one Cr(III)-containing dopant. Suitable starting materials are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in inorganic and/or organic liquids. Preference is given to the use of mixed nitrate solutions, chloride or hydroxide solutions which contain the corresponding elements in the requisite stoichiometric ratio.

A further advantage of the phosphor according to the invention consists in that the brightness of the phosphor increases with increasing temperature. This is surprising since the brightness of phosphors usually decreases with increasing temperature. This advantageous property according to the invention is of particular importance on use of the phosphor in high-power LEDs (>1 waft energy consumption) since these can come to operating temperatures of above 150° C.

The present invention furthermore relates to a process for the production of a phosphor element having the following process steps:
a) production of a Cr(III)-activated Al₂O₃ phosphor element from phosphor precursor suspensions or solutions by mixing at least two starting materials with at least one Cr(III)-containing dopant by wet-chemical methods,
b) subsequent thermal treatment of the Cr(III)-activated Al₂O₃ phosphor element.

Wet-chemical production generally has the advantage that the resultant materials have greater uniformity with respect to the stoichiometric composition, the particle size and the morphology of the particles from which the phosphor element according to the invention is produced. The wet-chemical preparation of the phosphor is preferably carried out by the precipitation and/or sol-gel process.

The flake-form phosphor element according to the invention is produced by conventional processes from the corresponding metal and/or rare-earth salts (for example for ruby preferably from an aluminium sulfate, potassium sulfate, sodium sulfate and chrome alum solution). The production process is described in detail in EP 763573.

The ruby flakes are then initially introduced as an aqueous suspension having a defined solids content, heated and can then be mixed with a further phosphor precursor suspension (for example YAG:Ce precursors). During this operation, phosphors or precursors thereof are applied to the ruby flakes under process conditions known to the person skilled in the art. After separation from the suspension, the material is dried and subjected to a calcination process, which can be carried out in a number of steps and (partially) under reducing conditions at temperatures up to 1700° C.

After a number of purification steps, the phosphor element is calcined for a number of hours at temperatures between 600 and 1800° C., preferably between 800 and 1700° C. During this operation, the phosphor precursor is converted into the actual flake-form phosphor element.

It is preferred for the calcination to be carried out at least partially under reducing conditions (for example using carbon monoxide, forming gas, pure hydrogen or at least vacuum or oxygen-deficiency atmosphere).

Furthermore, the phosphor elements according to the invention can also be produced using single-crystal synthesis methods (for example by the Verneuil method, see Kontakte (Merck) 1991, No. 2, 17-32 or Ullmann (4th) 15, 146, source: CD Römpp Chemie Lexikon [Römpp's Lexicon of Chemistry]—Version 1.0, Stuttgart/New York: Georg Thieme Verlag 1995). The methods mentioned are in use under names such as Kyropoulus, Bridgman-Stockbarger, Czochralski, Verneuil processes and as hydro-thermal synthesis. A distinction is also made between crucible-free zone melting and crucible drawing (source: CD Römpp Chemie Lexikon [Römpp's Lexicon of Chemistry]—Version 1.0, Stuttgart/New York: Georg Thieme Verlag 1995).

The present invention furthermore relates to an illumination unit having at least one primary light source whose emission maximum or maxima is (are) in the range from 370 nm to 670 nm, preferably between 380 nm and 450 nm and/or between 530 nm and 630 nm, where the primary radiation is partially or completely converted into longer-wavelength radiation by the phosphor element according to the invention and an additional conversion phosphor (this may be located directly on the surface of the ruby flakes according to the invention, or mixed into the ruby flakes as a further phosphor). In addition, scattering bodies may also be present in the phosphor mixture. This illumination unit preferably emits in white or emits light having a certain colour point (colour-on-demand principle).

In a preferred embodiment of the illumination unit according to the invention, the light source is a luminescent indium aluminium gallium nitride, in particular of the formula InᵢGaⱼAlₖN, where 0≦i, 0≦j, 0≦k, and i+j+k=1. Possible forms of light sources of this type are known to the person skilled in the art. They can be light-emitting LED chips having various structures.

In a further preferred embodiment of the illumination unit according to the invention, the light source is a luminescent arrangement based on ZnO, TCO (transparent conducting oxide), ZnSe or SiC or an arrangement based on an organic light-emitting layer.

In a further preferred embodiment of the illumination unit according to the invention, the light source is a source which exhibits electroluminescence and/or photoluminescence. The light source can furthermore also be a plasma or discharge source.

The flake-form phosphor element can either be dispersed in a resin or, given suitable size ratios, arranged directly on the primary light source or alternatively arranged at a distance therefrom, depending on the application (the latter arrangement also includes “remote phosphor technology”). The advantages of “remote phosphor technology” are known to the person skilled in the art and are revealed, for example, by the following publication: Japanese Journ. of Appl. Phys. Vol. 44, No. 21 (2005). L649-L651.

In a further embodiment, it is preferred for the optical coupling of the illumination unit between the phosphor element and the primary light source to be achieved by a light-conducting arrangement. This enables the primary light source to be installed at a central location and to be optically coupled to the phosphor by means of light-conducting devices, such as, for example, light-conducting fibres. In this way, lights matched to the illumination wishes and merely consisting of one or different phosphor elements, which may be arranged to form a light screen, and a light conductor, which is coupled to the primary light source, can be achieved. In this way, it is possible to position a strong primary light source at a location which is favourable for the electrical installation and to install lights comprising phosphor elements which are coupled to the light conductors at any desired locations without further electrical cabling, but instead only by laying light conductors.

It may furthermore be preferred for the illumination unit to consist of one or more phosphor elements which have identical or different structures.

The present invention furthermore relates to the use of the phosphor element according to the invention for the partial or complete conversion of the blue or near-UV emission from a luminescent diode.

Preference is furthermore given to the use of the phosphor element according to the invention for conversion of blue or near-UV emission into visible white radiation. Furthermore, the use of the phosphor element according to the invention for conversion of the primary radiation into a certain colour point in accordance with the colour-on-demand concept is preferred.

In a preferred embodiment, the phosphor element can be employed as conversion phosphor for visible primary radiation for the generation of white light. In this case, it is particularly advantageous for high luminous power if the phosphor element, in combination with a further conversion phosphor installed on the surface of the ruby flake according to the invention or admixed therewith, absorbs a certain proportion of the visible primary radiation (in the case of invisible primary radiation, this should be absorbed in its entirety) and the remainder of the primary radiation is transmitted in the direction of the surface opposite the primary light source, It is further-more advantageous for high luminous power if the phosphor element is as transparent as possible to the radiation emitted by it with respect to coupling-out via the surface opposite the material emitting the primary radiation.

In a further preferred embodiment, the phosphor element can be employed as conversion phosphor for UV primary radiation for the generation of white light. In this case, it is advantageous for high luminous power if the phosphor element absorbs all the primary radiation and if the phosphor element is as transparent as possible to the radiation emitted by it.

The present invention furthermore relates to the use of the phosphor element according to the invention in electroluminescent materials, such as, for example, electroluminescent films (also known as lighting films), in which, for example, zinc sulfide or zinc sulfide doped with Mn²⁺, Cu⁺ or Ag⁺ is employed as emitter, which emits in the yellow-green region. The range of applications of electroluminescent films are, for example, advertising, display backlighting in liquid-crystal displays and thin-film transistor (TFT) displays, self-illuminating motor vehicle licence plates, floor graphics (in combination with a non-crush and non-slip laminate), in display and/or control elements, for example in automobiles, trains, ships and aircraft, or also household, garden, measurement or sport and leisure equipment.

The following examples are intended to illustrate the present invention. However, they should in no way be regarded as limiting. All compounds or components which can be used in the compositions are either known and commercially available or can be synthesised by known methods. The temperatures indicated in the examples are always given in ° C. It furthermore goes without saying that, both in the description and also in the examples, the added amounts of the components in the compositions always add up to a total of 100%. Percentage data given should always be regarded in the given connection. However, they usually always relate to the weight of the part-amount or total amount indicated.

### EXAMPLE

### Example 1

### Production of Flake-Form Phosphor Particles of the Composition Al_{1.991}O₃:Cr_{0.009}

223.8 g of aluminium sulfate 18-hydrate, 114.5 g of sodium sulfate, 93.7 g of potassium sulfate and 2.59 g of KCr(SO₄)₂×12H₂O (chrome alum) are dissolved in 450 ml of deionised water at about 75° C. 2.0 g of a 34.4% titanium sulfate solution are added to this mixture, resulting in aqueous solution (a).

0.9 g of tert. sodium phosphate 12-hydrate and 107.9 g of sodium carbonate are dissolved in 250 ml of deionised water, giving aqueous solution (b).

The two aqueous solutions (a) and (b) are added simultaneously to 200 ml of deionised water with stirring over the course of 15 min. The mixture is stirred for a further 15 min. The resultant solution is evaporated to dryness, and the resultant solid is calcined at about 1200° C. for 5 h. Water is added in order to wash out free sulfate. After conventional purification steps using water and drying, the desired ruby flakes or the flake-form phosphors Al_{1.991}O₃:Cr_{0.009} are formed.

The flake-form phosphors are subjected to XRD phase analysis, and the X-ray reflections which can be observed can be assigned to highly crystalline Al₂O₃ (corundum phase). With the aid of an optical microscope and a scanning electron microscope, the average size of the phosphor flakes is determined. They have a diameter of up to 20 μm and a thickness of up to 200 nm.

### FIGURES

It is intended to explain the invention in greater detail below with reference to a number of working examples.

FIG. 1 shows the excitation spectrum of the phosphor element according to the invention which consists of the two crystal field-split 3d-3d bands of Cr³⁺ ([Ar]3d³).

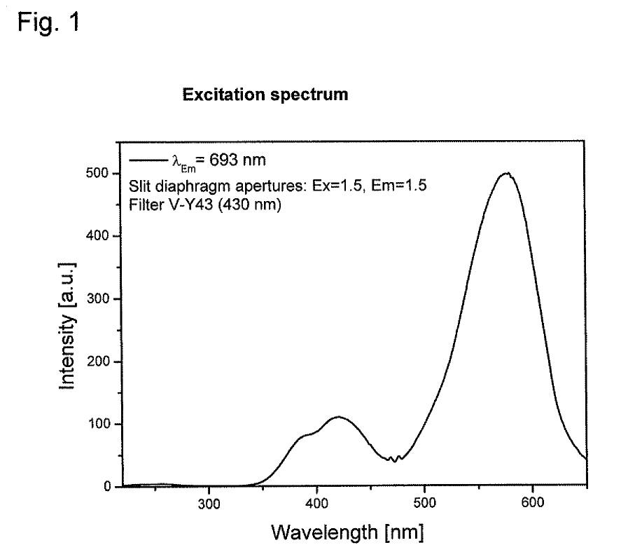

FIG. 2 shows the emission spectrum of the phosphor according to the invention on excitation at 580 nm (emission region of the orange-yellow conversion phosphor YAG:Ce or orthosilicates). An intense deep-red line emission results, with a quantum yield of 86%.

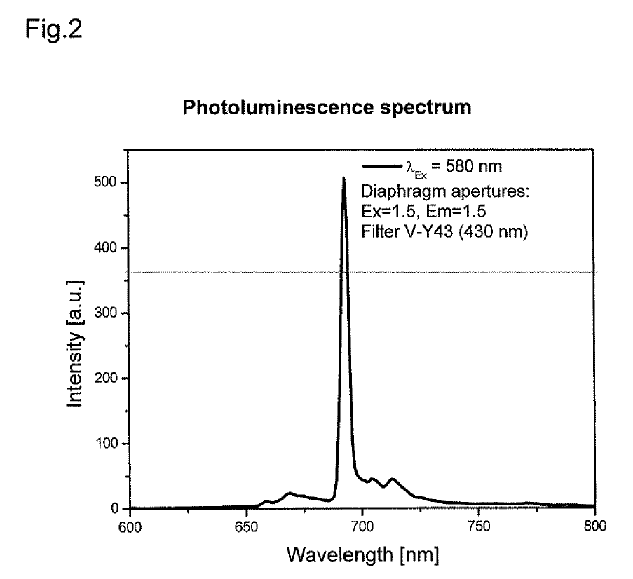

FIG. 3: pyramidal structures 2 can be produced on one surface of the flake (top) by treatment in accordance with the invention of the flake-form phosphor element. Nanoparticles consisting of SiO₂, TiO₂, ZnO, ZrO₂, Al₂O₃, Y₂O₃ etc. or mixtures thereof or particles consisting of the phosphor composition can likewise be applied in accordance with the invention to one surface (rough side 3) of the flake-form phosphor element.

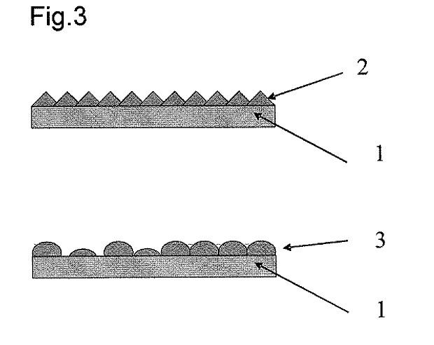

FIG. 4 shows the change in the emission spectrum of the phosphor according to the invention at temperatures between 20° C. and 250° C. at an excitation wavelength of 390 nm.

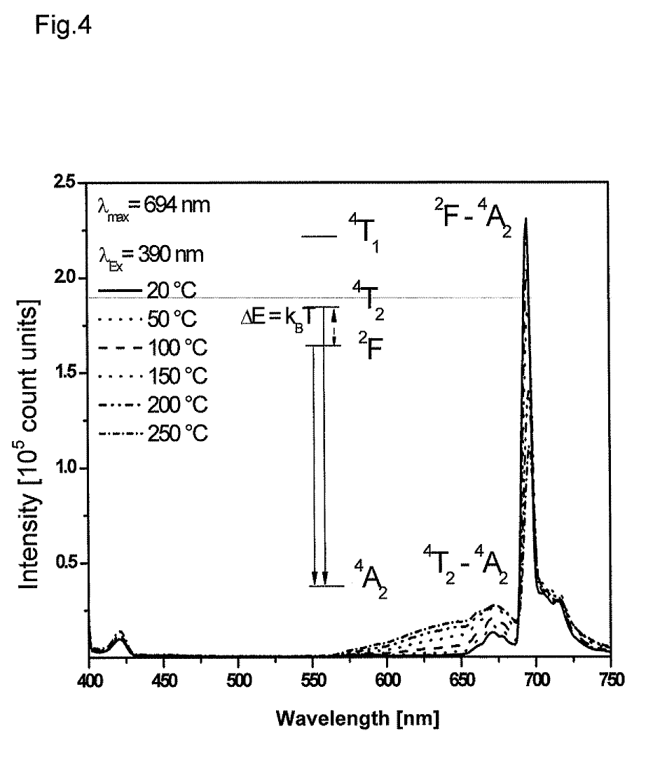

FIG. 5 shows the temperature quenching behaviour of the emission line in the spectrum of the phosphor according to the invention at 693 nm.

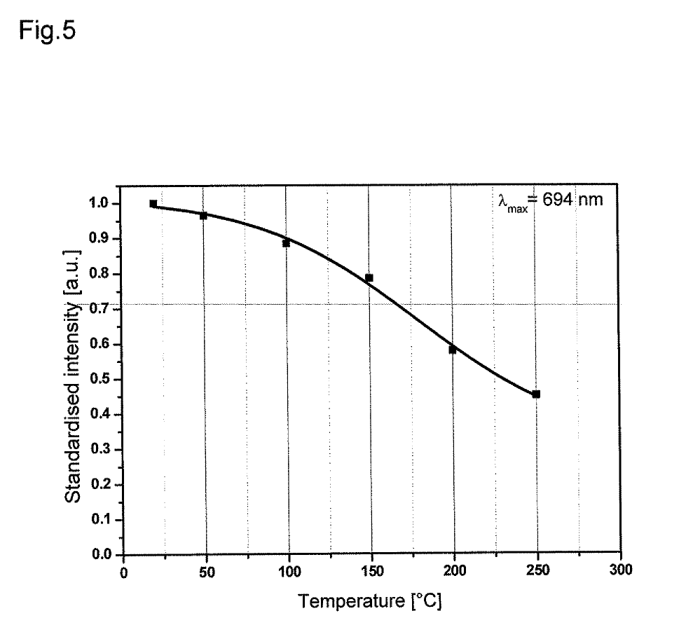

FIG. 6 shows the physically measured brightness (standardised integral, shown in a.u.=arbitrary units) and the brightness based on the sensitivity of the eye (LE=lumen equivalent in units lumens/watts) of the phosphor according to the invention.

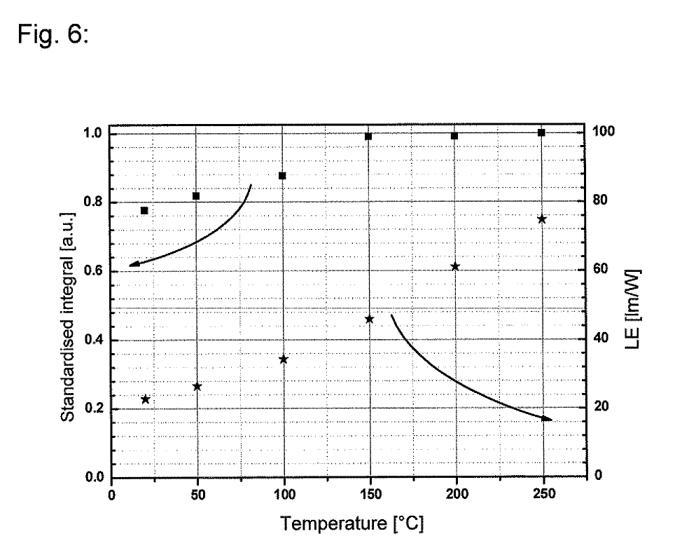

This listing of claims will replace all prior versions, and listings, of claims in the application:

1. Phosphor element comprising Cr(III)-activated aluminium oxide.

2. Phosphor element according to claim 1, characterised in that it comprises at least one further conversion phosphor.

3. Phosphor element according to claim 1, characterised in that it is in flake form and has a thickness between 50 nm and 20 μm, preferably between 150 nm and 5 μm.

4. Phosphor element according to claim 1, characterised in that the flake-form phosphor element has an aspect ratio of 1:1 to 400:1, preferably of 3:1 to 100:1.

5. Phosphor element according to claim 1, characterised in that it has a structured surface.

6. Phosphor element according to claim 1, characterised in that it has a rough surface which carries nanoparticles comprising SiO₂, TiO₂, Al₂O₃, ZnO, ZrO₂ and/or Y₂O₃ or mixed oxides thereof or particles comprising the phosphor composition.

7. Phosphor element according to claim 2, characterised in that, besides Cr(III)-activated aluminium oxide, it comprises at least one further phosphor material of the following: (Y,Gd,Lu,Sc,Sm,Tb)₃(Al,Ga)₅O₁₂:Ce (with or without Pr), (Ca,Sr,Ba)₂SiO₄:Eu, YSiO₂N:Ce, Y₂Si₃O₃N₄:Ce, Gd₂Si₃O₃N₄:Ce, (Y,Gd,Tb,Lu,SM,SC)₃Al₅₋ₓSiₓO₁₂₋ₓN,:Ce, SrAl₂O₄:Eu, Sr₄Al₁₄O₂₅:Eu, (Ca,Sr,Ba)Si₂N₂O₂:Eu, SrSiAl₂O₃N₂:Eu, (Ca,Sr,Ba)₂Si₅N₈:Eu, (Ca,Sr)AlSiN₃:Eu, zinc/alkaline earth metal orthosilicates, copper/alkaline earth metal orthosilicates, iron/alkaline earth metal orthosilicates, molybdates, tungstates, vanadates, group III nitrides, oxides, in each case individually or mixtures thereof with one or more activator ions, such as Ce, Eu, Mn, Cr and/or Bi.

8. Phosphor element according to claim 1, obtainable by mixing at least two starting materials with at least one Cr(III)-containing dopant by wet-chemical methods and subsequent thermal treatment.

9. Phosphor element according to claim 8, characterised in that the starting materials and the dopant are inorganic and/or organic substances, such as sulfates, nitrates, carbonates, hydrogencarbonates, phosphates, carboxylates, alcoholates, acetates, oxalates, halides, organometallic compounds, hydroxides and/or oxides of the metals, semimetals, transition metals and/or rare earths, which are dissolved and/or suspended in inorganic and/or organic liquids.

10. Phosphor element according to claim 1, characterised in that it has increasing brightness and increasing lumen equivalent with increasing operating temperature.

11. Process for the production of a phosphor element having the following process steps:
a) production of a Cr(III)-activated Al₂O₃ phosphor element from phosphor precursor suspensions or solutions by mixing at least two starting materials with at least one Cr(III)-containing dopant by wet-chemical methods,
b) subsequent thermal treatment of the Cr(III)-activated Al₂O₃ phosphor element.

12. Process according to claim 11, characterised in that the phosphor precursor is prepared in step a) by wet-chemical methods from organic and/or inorganic metal and/or rare-earth salts by means of sol-gel processes and/or precipitation processes.

13. Process according to claim 11, characterised in that the surface of the phosphor element is coated with nanoparticles comprising SiO₂, TiO₂, Al₂O₃, ZnO, ZrO₂ and/or Y₂O₃ or mixed oxides thereof or with nanoparticles comprising the phosphor composition.

14. Illumination unit having at least one primary light source whose emission maximum is in the range 370 nm to 670 nm, preferably between 380 nm and 450 nm and/or between 530 nm and 630 nm, where this radiation is partially or completely converted into longer-wavelength radiation by a phosphor element according to claim 1.

15. Illumination unit according to claim 14, characterised in that the light source is a luminescent indium aluminium gallium nitride, in particular of the formula InᵢGaⱼAlₖN, where 0≦j, 0≦j, 0≦k, and i+j+k=1.

16. Illumination unit according to claim 14, characterised in that the light source is a luminescent compound based on ZnO, TCO (transparent conducting oxide), ZnSe or SiC.

17. Illumination unit according to claim 14, characterised in that the light source is a material based on an organic light-emitting layer.

18. Illumination unit according to claim 14, characterised in that the light source is a source which exhibits electroluminescence and/or photoluminescence.

19. Illumination unit according to claim 14, characterised in that the light source is a plasma or discharge source.

20. Illumination unit according to claim 14, characterised in that the phosphor element is arranged directly on the primary light source and/or at a distance therefrom.

21. Illumination unit according to claim 14, characterised in that the optical coupling between the phosphor element and the primary light source is achieved by a light-conducting arrangement.

22. Illumination unit according to claim 14, characterised in that the phosphor elements are an arrangement comprising one or more phosphor elements which have identical or different structures.

23. A method comprising partially or completely converting blue or near-UV emission from a luminescent diode using a phosphor element according to claim 1.

24. A method comprising converting primary radiation into a certain colour point in accordance with the colour-on-demand concept using a phosphor element according to claim 1.

25. A method comprising converting blue or near-UV emission into visible white radiation using a phosphor element according to claim 2.

26. In a electroluminescent material containing ZnS or ZnS doped with Mn²⁺, Cu⁺ or Ag⁺ as emitter, the improvement wherein said material contains a Use of the phosphor element according to claim 1.
